(19) United States
(12) Patent Application Publication
(10) Pub. No.: US 2026/0299145 A1
(43) Pub. Date: Oct. 1, 2026

(54) RADIOMETRIC MEASURING DEVICE HAVING A CONNECTION ADAPTER

(71) Applicant: VEGA Grieshaber KG, Wolfach (DE)

(72) Inventors: Ralf Körnle, Zell a.H. (DE); Christian Sum, Wolfach (DE); Fabian Rank, Wolfach (DE); Florian Osswald, Gutach (DE); Benjamin Mellert, Steinach (DE)

(21) Appl. No.: 19/480,057

(22) PCT Filed: Apr. 30, 2024
(86) PCT No.: PCT/EP2024/061830

§ 371 Date: Oct. 30, 2025

(30) Foreign Application Priority Data
May 2, 2023 (DE) 10 2023 111 279.1

(51) Int. Cl. G01T 1/20

(52) U.S. Cl. CPC G01T 1/20188

(57) ABSTRACT

The invention relates to a radiometric measuring device, comprising a housing, wherein a light detector is arranged in the housing and wherein a connection adapter is arranged in the housing, wherein the connection adapter serves to establish an electrical connection between the light detector and a sensor electronics system, wherein the connection adapter is of at least two-part design and has a first detector housing part and a second connection housing part, wherein the first detector housing part and the second connection housing part are displaceable relative to each other in the axial direction and/or are rotatable relative to each other. The invention also relates to a connection adapter and to a method for assembling a radiometric measuring device.

The invention relates to a radiometric measuring device according to Patent Claim 1. The invention further relates to a connection adapter for a radiometric measuring device according to Patent Claim 15 and methods in each case for mounting a radiometric measuring device according to Patent Claims 17 and 18.

In radiometric fill level measurement, the fill level state of tank containers is for example determined with the aid of gamma radiation from a caesium or cobalt source. The measurement is based on the premise that the gamma rays which are emitted are attenuated when they penetrate matter and the radioactive radiation which still penetrates the material is detected by means of a radiometric measuring device.

Such radiometric measuring devices generally contain a scintillator which for example consists of a crystal, a light detector and evaluation electronics. Emitted gamma radiation which impinges on the scintillator generates flashes of light in the scintillator. These reach the light detector (partly via optical elements), where they are converted into electric pulses and amplified. The pulse rate (number of pulses per second) is a measure for the intensity of the radiation. Depending on the calibration, the pulse rate is converted by the evaluation electronics into a fill-level signal, limit-switch signal, density signal or concentration signal.

For reasons of explosion protection in particular, the components scintillator, light detector and sensor electronics are usually arranged in housing parts which are separate from one another. The scintillator is generally arranged in a process-orientated scintillator housing part. This scintillator housing part is then separated by means of a glass window from a central light detector housing part, in which the light detector is arranged. Flashes of light generated by the scintillator can strike the light detector through the glass window. In the central housing part, the light detector is usually arranged together with detector electronics. The detector electronics are used for converting the light pulses that are counted into an electrical signal. This signal is forwarded to sensor electronics which are arranged in a sensor electronics housing part. The connection between the sensor electronics and the detector electronics generally takes place via contact pins which extend through an explosion prevention glass feedthrough between the sensor electronics housing and the light detector housing.

Radiometric measuring devices are usually used under harsh conditions. Therefore, the detector electronics are often also exposed to high temperatures, vibrations and also radioactive radiation, which can result in them needing 000to be replaced at regular intervals.

The underlying object of the invention is to provide a radiometric measuring device, a connection adapter and a method for mounting a radiometric measuring device, by means of which a particularly easy mounting of the connection adapter in the housing of the radiometric measuring device and a simple replacement of the detector electronics are enabled.

The object is achieved according to the invention using the features of the independent claims. Further practical embodiments and advantages are described in connection with the dependent claims.

A radiometric measuring device according to the invention comprises a housing (also referred to as a light detector housing) having a light detector arranged therein. The light detector is used to detect flashes of light which are generated by a scintillator and forwarded to the light detector. The light detector is in particular designed as an elongated, cylindrical body.

A connection adapter is further arranged in the housing, wherein the connection adapter is used for producing an electrical connection between the light detector and sensor electronics. The sensor electronics are in particular arranged in a separate sensor electronics housing which is adjacent to the housing. The sensor electronics are used inter alia for signal processing of the electrical signal supplied by the detector electronics. As already mentioned previously, contacting of the sensor electronics takes place in particular by means of contact pins which extend through a glass feedthrough.

The connection adapter is here formed at least in two parts. The connection adapter comprises a first detector part. In particular, the first detector housing part has detector electronics for connection to the light detector. The detector electronics are used in particular for converting the light pulses that are counted into an electrical signal. The detector electronics and the sensor electronics are preferably arranged separately and spaced from one another, particularly for reasons of explosion protection and since the sensor electronics are more temperature sensitive. The first detector housing part in particular surrounds the light detector at least partially.

The connection adapter additionally comprises a second connection housing part. In particular, the second connection housing part has a connection plug for connecting to the sensor electronics, particularly to the contact pins. The first detector housing part and the second connection housing part are displaceable relative to one another in the axial direction and/or rotatable relative to one another.

The connection adapter is used primarily to produce the electrical connection between the light detector and sensor electronics with a single compact part (a single front-end group). In the event of an exchange of the detector electronics, only a single part has to be inserted into the housing. By means of the connection adapter, fixing of the detector electronics in particular is already realized, so no additional connection of the detector electronics to the housing, in particular no screw fastening, is required. Due to the detector electronics integrated into the connection adapter, this is simple to replace.

Due to the two-part design of the connection adapter, an axial displaceability and/or rotatability are realized, which on the one hand make tolerance compensation possible and/or—as also explained in detail in the following in connection with the method—also enable a screw fastening of a base body and a cover of the housing with the connection adapter already inserted.

In a practical embodiment, the first detector housing part and the second connection housing part are loaded with a spring force in the axial direction. That is to say the axial displaceability is assisted by means of a spring force. The first detector housing part and the second connection housing part are preloaded against one another, specifically such that they are pushed apart in the axial direction. During mounting of the radiometric measuring device, a base body and a cover of the housing in particular are screwed together and the two housing parts are pushed together in the axial direction counter to the spring force. Due to the spring force, the second housing part is pushed with the connection plug against the contact pins and the first housing part is pushed against the light detector. Due to the preloading and axial displaceability, a temperature-related expansion of the individual components can additionally be compensated. In particular, a spring (preferably a coil spring) is arranged in a captive manner between the first housing part and the second housing part. This can be realized in that the spring in each case bears against a housing part at a stop. The stop is in particular formed on the first housing part by a shoulder and on the second housing part by a circumferential collar.

In particular, the first detector housing part is formed in a substantially cylindrical manner and surrounds and fixes the detector electronics. The first detector housing part in this case has a detector section and an adjacent guide section. The detector section has a larger diameter than the guide section. Accordingly, a shoulder is formed at the transition between the detector section and the guide section. The detector section surrounds the light detector and is separated from the guide section by an intermediate ceiling.

The second connection housing part is in particular likewise formed in a cylindrical manner. It has a cylindrical surface, from which a circumferential collar extends on one side. The collar extends on the side facing away from the first detector housing part. The second connection housing part is plugged into the first detector housing part, wherein the maximum insertion depth is limited by the collar.

In order to realize a defined relative axial movement between the first detector housing part and the second connection housing part, the first detector housing part and the second connection housing part in particular have corresponding guide means. In particular, the first detector housing part has at least one slot, in which a resilient catch of the second connection housing part is arranged in a penetrating manner. Preferably, the first detector housing part has a plurality of slots distributed over its circumference and the second connection housing part has resilient catches which correspond thereto. The at least one slot is formed in particular in the guide section of the first detector housing part. The second connection housing part is plugged into the first detector housing part and the catches spring outwards in the radial direction. The guide structures are simultaneously used as anti-rotation protection.

The maximum spring travel of the spring—and also the maximum length of the connection adapter in the axial direction—is limited by the previously described catch stopping at the upper end of a corresponding slot.

In a further practical embodiment, the second connection housing part itself is formed in two parts and has an intermediate part and a ring part, wherein the ring part is rotatable relative to the intermediate part. The intermediate part then in particular has the at least one previously described resilient catch and is at least partially plugged into the first detector housing part.

The ring part has at least one catch at one end and a circumferential collar at the other end. The ring part is plugged into the intermediate part so that the collars come to bear against one another and the at least one catch engages behind the end of the intermediate part. As a result, an axial fixing of ring part and intermediate part takes place. The circumference of the ring part bears against the intermediate part and is fitted such that it is rotatable relative to the intermediate part.

The second connection housing part—and, in the case of a two-part design in particular, the ring part—in particular accommodates additional electronics with the connection plug. The additional electronics in particular comprises a circuit board/printed circuit board, which is spaced from the detector electronics for reasons of explosion protection and EMC reasons. In particular, the circuit board is clipped to the second connection housing part or possibly to the ring part. The second connection housing part (or the ring part) and the circuit board in particular have corresponding features in order to ensure a unique installation location of the circuit board in the second connection housing part. Thus, the second connection housing part can have a projection and the circuit board can have a corresponding notch.

In the case of a two-part design of the second connection housing part, the ring part can correspondingly be rotated and positioned relative to the intermediate part such that the connection plug is aligned with the connection pins which penetrate the cover.

In particular, the second connection housing part has at least one fixing structure extending in the axial direction. The fixing structure extends in particular on the side of the collar facing away from the first detector housing part. Preferably, a plurality of fixing structures are arranged in a distributed manner over the circumference. The at least one fixing structure is used for the unique positioning of the second connection housing part in relation to the housing or the cover and above all in relation to the connection pins. The fixing structure is projections or pins protruding in the axial direction in particular. The at least one fixing structure in the installation location is then accommodated in a corresponding recess in the cover and in particular in the glass feedthrough. The second connection housing part is then fixed against rotations in relation to the cover. In the case of the two-part design of the connection housing part, the at least one fixing structure is arranged on the ring part in particular. The ring part can rotate relative to the intermediate part and the first detector housing part. In order to additionally fix the connection adapter on the cover in the axial direction, the second connection housing part in particular has means for positive fastening to the housing and in particular to the glass feedthrough that is arranged in the cover. The means for positive fastening in particular is snap-in hooks extending in the axial direction, which can rebound outwards in the radial direction. These snap-in hooks engage behind the glass feedthrough and snap into a depression or groove provided therefor, so that the second connection housing part is fastened to the glass feedthrough. This is advantageous in particular during mounting if the connection adapter as a whole is fastened to the cover with integrated glass feedthrough and is then screwed with the cover into the housing.

The electrical connection between the connection plug and the detector electronics takes place in particular by means of a flexible conductor or a cable. The flexible conductor in this case can be guided along the first detector housing part on the inside or outside. It may be a ribbon cable in particular. Both in the case of an axial displacement and any rotation of the first detector housing part relative to the second connection housing part, the flexible conductor has sufficient play so that it is ensured that the electrical connection is maintained in the event of displacement and/or rotation. The flexible conductor is configured in particular such that it is not strained in the event of multiple relative rotation of the first detector housing part and second connection housing part (particularly the ring part) and also in the event of maximum axial excursion. The “excess” part of the flexible conductor is in particular arranged in the region between the intermediate ceiling and the additional electronics in the cylindrical intermediate part or in the guide section. The flexible conductor can in particular already be pre-bent into a plurality of windings and is unwound during mounting, specifically during screw fastening of the cover and base body.

In one embodiment, the connection adapter guide structures on its outer side for the flexible conductor in the case of external cable routing. Thus, a channel may be formed on the outer side of the first detector housing part, in which the conductor is inserted, and webs, which respectively protrude laterally into the channel, are additionally formed preferably alternately from the one side and from the other side, wherein the webs only extend over part of the channel width. The flexible conductor can be introduced, in particular via an opening in the guide section, as far as below the additional circuit board.

Alternatively, the detector electronics can be contacted by means of a pin header, wherein the pin header extends through the intermediate ceiling. The flexible conductor then extends from the part of the pin header which protrudes out of the intermediate ceiling up to below the additional electronics, inside the guide section.

In a further practical embodiment, the first detector housing encloses an interior in which the detector electronics are arranged. This interior can be filled with potting compound in order to protect the detector electronics. To pour in the potting compound, an opening is formed in the base plate.

The interior is in particular surrounded by the detector section, the intermediate ceiling and the base plate.

In particular, the detector housing is also realized in two parts and comprises a support part and an outer part. The support part is particularly plugged into the outer part, wherein the relative position of support part and outer part is determined uniquely by corresponding retaining bars and guide rails. The outer part is in particular formed in a cylinder-shaped manner and connected to the base plate of the support part by means of a clip connection.

The support part in particular has means for fixing the detector electronics, particularly a main circuit board. The support part in particular has a base plate which has an insertion opening for the light detector. A plurality of retaining bars extend from the base plate in the axial direction, which are used to clip in and/or plug on the main circuit board of the detector electronics. In particular, the retaining bars have catches which laterally surround the main circuit board and engage behind it and fix it in the axial direction. Alternatively or additionally, the retaining bars have fixing pins which penetrate the main circuit board and determine a unique position of the main circuit board and fix the same against rotation.

At least one fixing pin in particular is arranged on the underside of the base plate, i.e. the end of the connection adapter opposite the connection plug. This is in particular accommodated in a corresponding opening in the base body of the housing. By means of the fixing pin, a unique position of the second detector housing part is realized in relation to the base body and anti-rotation protection is realized. This is advantageous in particular in embodiments in which the first housing part and second housing part are rotatable relative to one another.

Furthermore, inwardly resilient support ribs for cushioning and centred mounting of the light detector can be arranged on the base plate. To this end, the first detector housing part—and in particular the base plate of the support part—has inwardly resilient support ribs which bear against the light detector and are arranged surrounding the same.

In a further practical embodiment, the connection adapter has support elements on its outer side for resilient support of the connection adapter in the housing of the radiometric measuring device. Here, these may for example be elements that protrude in the radial direction, such as ribs or blades which extend over a part of the circumference and can deflect in the radial direction. Thus, the transmission of vibrations from the housing to the connection adapter can be damped.

The invention further relates to a connection adapter having a first detector housing part having detector electronics for connection to a light detector and a second connection housing part having a connection plug for producing an electrical connection between the light detector and sensor electronics. The first housing part and the second housing are displaceable relative to one another in the axial direction and/or rotatable relative to one another. With respect to the advantages and further features of such a connection adapter, reference is made to the preceding description.

The invention also relates to a method for mounting (i.e. for assembling) a radiometric measuring device, particularly a radiometric measuring device as described previously. In this case, the light detector is first connected to the first detector housing part. To do this, the light detector is in particular pushed into the first detector housing part until the connection contacts of the light detector penetrate the main circuit board of the detector electronics.

Subsequently, the thus pre-mounted connection adapter is arranged in the housing with the first detector housing part and the second connection housing part. The connection plug is connected to the sensor electronics and the second connection housing part is connected in a rotationally fixed manner to a c over of the housing. To do this, the second connection housing part is in particular orientated such that the connection plug contacts contact pins of the sensor electronics. The orientation is specified in particular by means of at least one fixing structure. In particular, the connection adapter is additionally positively fixed to the cover also in the axial direction by means of means for positive fastening (particularly snap-in hooks). The connection adapter is then connected to the cover in a rotationally fixed manner and, in the case of the subsequent screw fastening of the base body and the cover, the connection adapter co-rotates as a whole. Due to the relative axial displaceability of the first detector housing part and the second connection housing part, this length change that occurs during screw fastening can be compensated.

In an alternative mounting method, the pre-mounted connection adapter can be arranged in the housing with the first detector housing part and the second connection housing part, wherein the detector housing part is connected in a rotationally fixed manner to a base body of the housing. This is realized in particular by means of the previously described fixing structures on the first detector housing part. Furthermore, the connection plug is connected to the sensor electronics and the second connection housing part is connected in a rotationally fixed manner to a cover of the housing. To do this, the ring part of the second connection housing part is in particular orientated such that the connection plug contacts contact pins of the sensor electronics. Furthermore, anti-rotation protection is realized in particular by means of at least one fixing pin. Following the fixing of the first detector housing part on the base body and the second connection housing part on the cover, the base body and the cover are subsequently screwed together. Due to the relative axial displaceability of the first detector housing part and the second connection housing part, this length change that occurs during screw fastening can be compensated. Furthermore, the second connection housing part (and actually the ring part here) is rotatable relative to the first detector housing part, as a result of which the screwing motion can also be compensated.

Further practical embodiments are described in the following in connection with the figures. In the figures:

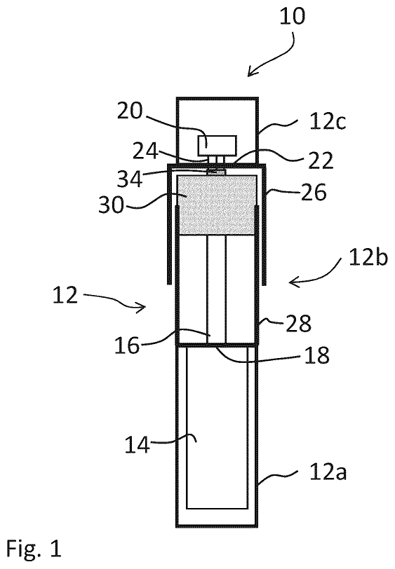

FIG. 1 shows a radiometric measuring device in a schematic illustration,

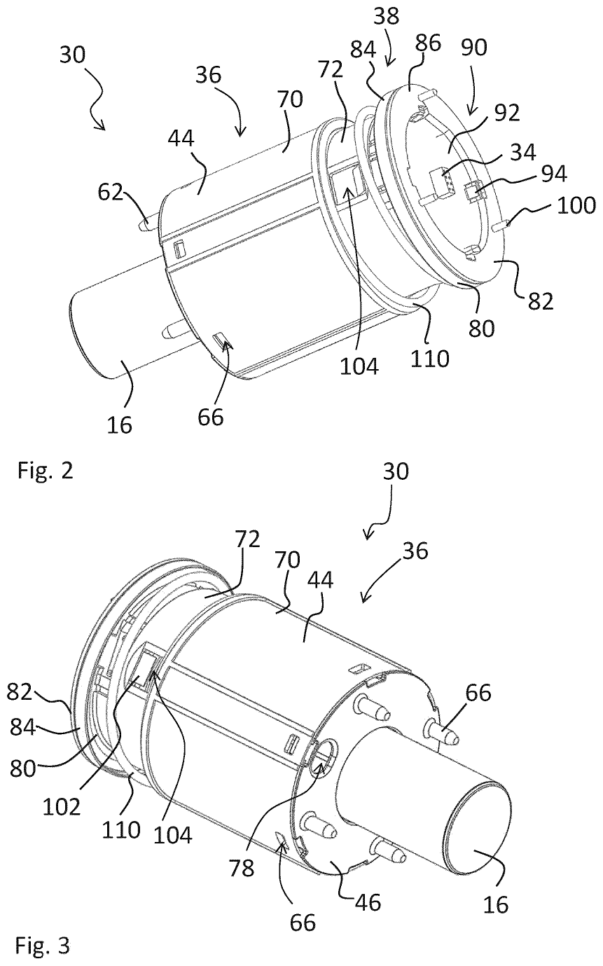

FIG. 2 shows a connection adapter in a first embodiment in a perspective view from obliquely above,

FIG. 3 shows the connection adapter from FIG. 2 in a perspective view from obliquely below,

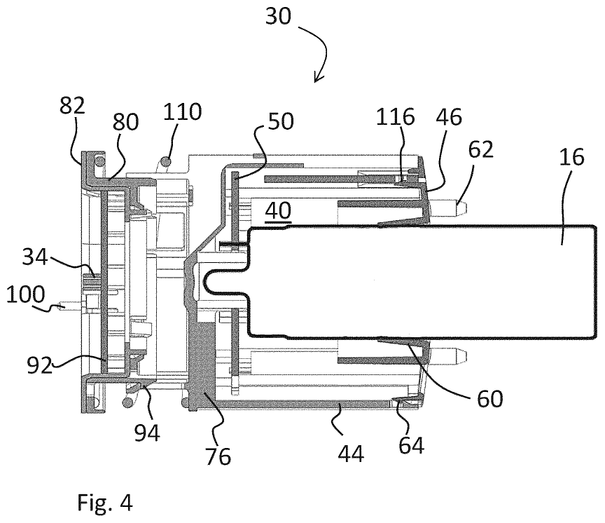

FIG. 4 shows the connection adapter from FIGS. 2 and 3 in a cross section,

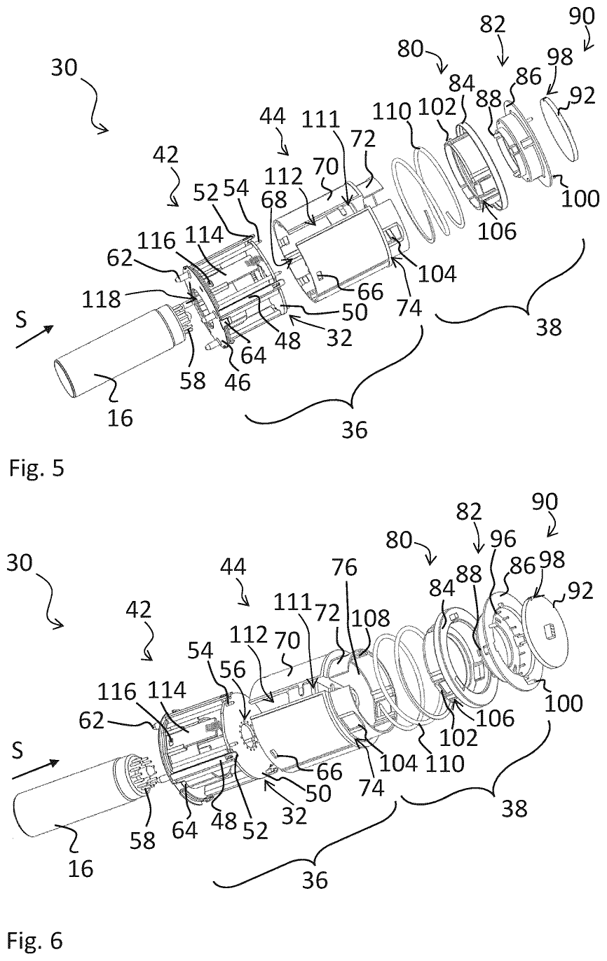

FIG. 5 shows the connection adapter according to the first embodiment in an exploded view from the side,

FIG. 6 shows the connection adapter according to the first embodiment in an exploded view from obliquely above,

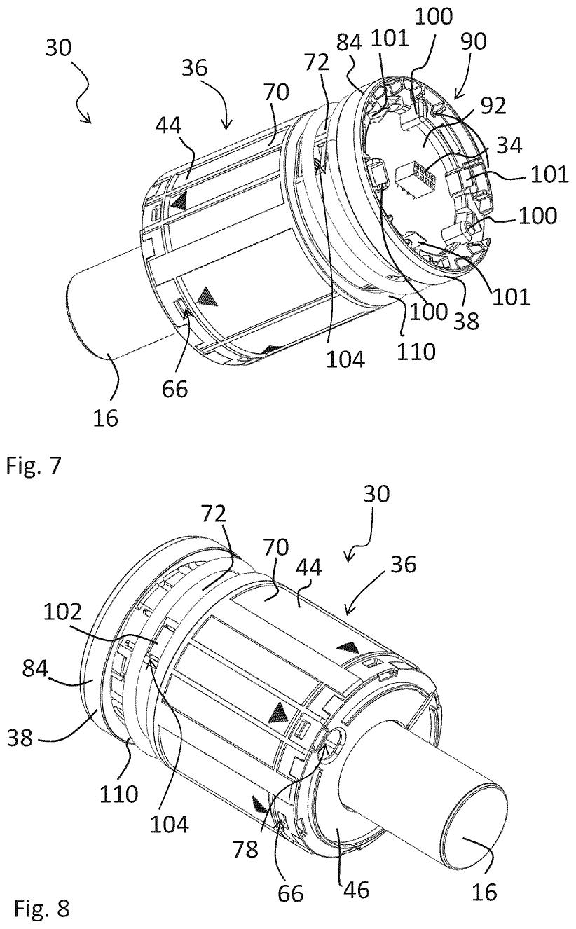

FIG. 7 shows a connection adapter in a second embodiment in a perspective view from obliquely above,

FIG. 8 shows the connection adapter from FIG. 7 in a perspective view from obliquely below,

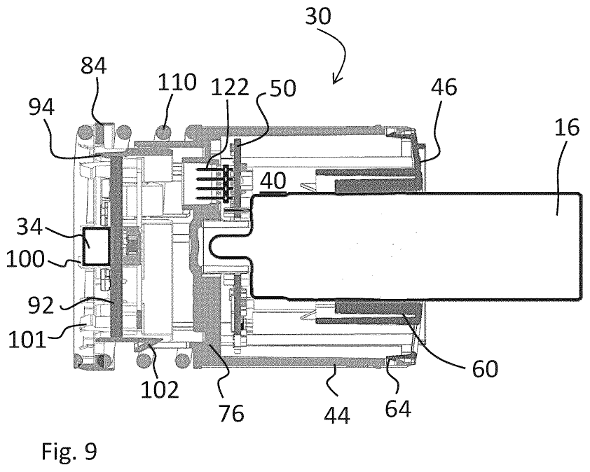

FIG. 9 shows the connection adapter from FIGS. 7 and 8 in a cross section,

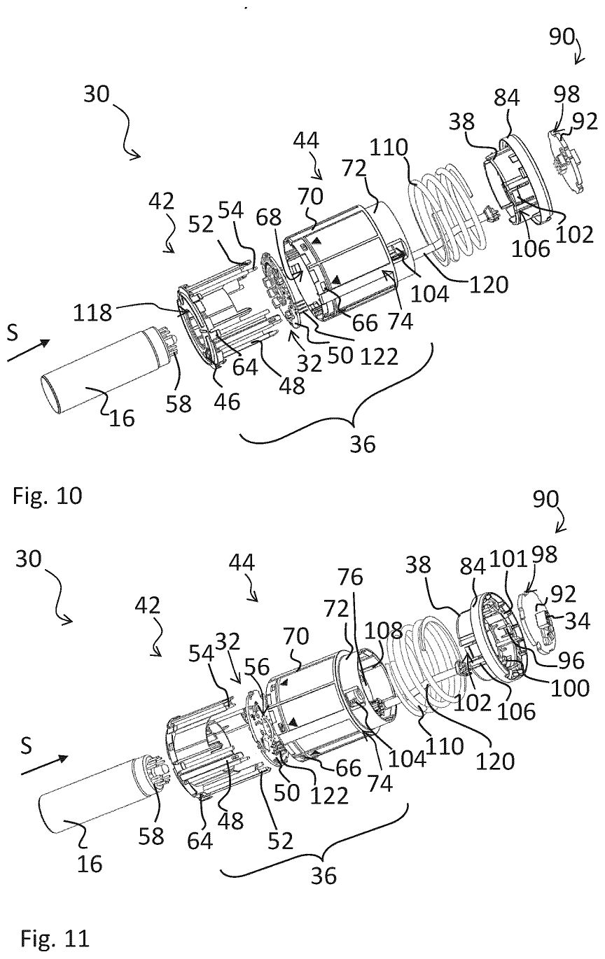

FIG. 10 shows the connection adapter according to the second embodiment in an exploded view from the side,

FIG. 11 shows the connection adapter according to the second embodiment in an exploded view from obliquely above.

A radiometric measuring device 10 is illustrated schematically in FIG. 1. The radiometric measuring device 10 here has a housing 12 with a plurality of parts. In a (lower) scintillator housing part 12a, a scintillator 14 is arranged, which scintillator is used for detecting radioactive radiation and generates flashes of light. A light detector 16 is arranged in a (here central) light detector housing part 12b. The light detector 16 converts the flashes of light generated by the scintillator 14 into an electrical signal. The scintillator housing part 12a and the light detector housing part 12b are separated from one another for reasons of explosion protection. An optical window 18 is arranged between the scintillator housing part 12a and the light detector housing part 12b, which optical window is transparent for the flashes of light that are generated.

An (upper) sensor electronics housing part 12c adjoins the (central) light detector housing part 12b. Sensor electronics 20 (not illustrated here) are arranged in the upper sensor electronics housing part 12c. Also, the light detector housing part 12b and the sensor electronics housing part 12c are separate from one another. A glass feedthrough 22 is arranged therebetween, through which contact pins 24 extend, by means of which an electrical connection between the sensor electronics 20 and the light detector 16 can be produced.

As can also be seen in FIG. 1, the light detector housing part 12a is formed in two parts and has a cover 26 and a base body 28.

As is already visible in FIG. 1, the light detector 16 is here surrounded at least partially by a compact connection adapter 30. The connection adapter 30 has detector electronics 32 for connection to the light detector 16 and a connection plug 34 for contacting the contact pins 24.

In the following, the connection adapter 30 together with light detector 16 is described in detail in connection with FIGS. 2 to 6 according to a first embodiment.

The connection adapter 30 is a compact component which on the one hand surrounds and contacts a part of the light detector 16 facing away from the scintillator 14 and on the other hand produces the contact to the sensor electronics 20.

The connection adapter 30 is here formed in multiple parts and comprises a first detector housing part 36 and a second connection housing part 38.

The first detector housing part 36 encloses an interior 40 and surrounds and fixes the detector electronics 32 (cf. FIG. 4). The detector housing part 36 itself is formed in two parts and comprises a support part 42 and an outer part 44 (cf. FIGS. 5 and 6).

The support part 42 (which can be seen well in FIGS. 4 to 6) comprises a base plate 46 and retaining bars 48 extending therefrom in the axial direction. The retaining bars 48 are formed in a slightly resilient manner and guided laterally past a main circuit board 50 of the detector electronics 32. At their ends, the retaining bars 48 in each case have a catch 52, using which they engage behind the main circuit board 50 of the detector electronics 32 and thus fix it in a clamping manner. Furthermore, one fixing pin 54 is arranged at the end of the retaining bars 48 in each case, which fixing pin is used for anti-rotation protection of the main circuit board 50. The retaining bars 48 and fixing pins 54 are not equidistantly distributed, but rather specify a unique relative position of the main circuit board 50 relative to the support part 42. The main circuit board 50 has a plurality of connection openings 56 arranged on a circle, through which connection contacts 58 of the light detector 16 extend.

Furthermore, the support part 42 has support ribs 60 that spring inwards in the radial direction, which support ribs bear against the light detector 16 and centre and resiliently support the same.

Four fixing pins 62 extend from the base plate 46 on the side facing away from the retaining bars 48. These fixing pins are likewise arranged such that only in a specified relative position can they be inserted into corresponding openings (not illustrated) in the base body 28 of the light detector housing 12b. At the same time, this realizes anti-rotation protection of the detector housing part 36 in relation to the base body 28.

The support part 42 is plugged with the retaining bars 48 and the detector electronics 32 into the outer part 44 and fixed in the axial direction by means of catches 64 which engage into a corresponding opening 66. For a unique relative position of the support part 42 in the outer part 44, the outer part 44 has guide rails 68 extending in the axial direction on its inner side, in which guide rails the retaining bars 48 are accommodated. As a result, anti-rotation protection is realized. The support part 42 is pushed so far into the outer part 44 until the catches 64 arranged on the base plate 46 deflect outwards into the corresponding opening 66 in the outer part 44.

The outer part 44 has a cylindrical base body with a first detector section 70 with a larger diameter and a guide section 72 with a smaller diameter adjacent thereto. Due to the two different diameters, the outer part 44 has a shoulder 74. The detector section 70 and the guide section 72 are separated by an intermediate ceiling 76.

The detector section 70 with the intermediate ceiling 76 and the base plate 46 enclose the interior 40 with the detector electronics 32. An opening 78 is formed in the base plate 46, via which potting compound can be poured into the interior 40 to protect the detector electronics 32.

The connection housing part 38 is itself also formed in multiple parts and has an intermediate part 80 and a ring part 82.

The intermediate part 80 is formed in a cylindrical manner and has a circumferential collar 84 on one side. The ring part 82 is likewise formed in a cylindrical manner and has a circumferential collar 86. The ring part 82 is plugged with the cylindrical section into the intermediate part 80 in such a manner that the two circumferential collars 84, 86 come to bear against one another. The intermediate part 80 and the ring part 82 are fixed positively in the axial direction. For that, the ring part 82 has catches 88 which engage behind a lower edge of the intermediate part 80. The positive engagement in the axial direction is created on the one hand by the catches 88 and on the other hand by the bearing collar 86.

The ring part 82 accommodates additional electronics 90 with an additional circuit board 92 with the connection plug 34 in a clamping manner. To this end, the ring part 82 likewise has catches 94 which spring outwards during insertion of the additional circuit board 92 and subsequently form an end support for the additional circuit board 92. For a unique positioning of the additional circuit board 92 in the ring part 82, the ring part 82 has a projection 96 and the additional circuit board 92 has a corresponding notch 98.

Furthermore, the ring part 82 has three fixing structures 100 in the form of pins which are arranged on the end face or the collar 86 of the ring part 82. Together with the connection plug 34, a unique positioning of the ring part 82 relative to the glass feedthrough 22 and the contact pins 24 is thus specified and anti-rotation protection is realized. The intermediate part 80 of the second connection housing part 38 is plugged into the outer part 44 of the first detector housing part 36. The intermediate part 80 is in this case plugged into the cylindrical guide section 72 with a smaller diameter. The intermediate part 80 has catches 102, which spring outwards in the radial direction and which are accommodated in a slot 104 of the outer part 44, which slot extends in the axial direction. Furthermore, the intermediate part 80 has two grooves 106 in each case laterally adjacent to the catches 102 and extending in the axial direction, into which grooves ribs 108 engage on the inner side of the outer part 44. The ribs 108 and corresponding grooves 106 and also the catches 102 and slots 104 realize guidance and anti-rotation protection.

The intermediate part 80 and the outer part 44 are displaceable relative to one another in the axial direction. As a result, the first detector housing part 36 and the second connection housing part 38 are also displaceable relative to one another in the axial direction.

A coil spring 110 is arranged between the shoulder 74 of the outer part 44 and the collar 84 of the intermediate part 80. The coil spring 110 is arranged between the shoulder 74 and the collar 84 in a captive manner. The coil spring 110 loads the first detector housing part 36 and the second connection housing part 38 with a spring force which leads to the first detector housing part 36 and the second connection housing part 38 being pushed apart in the axial direction. During mounting of the connection adapter 30 in the light detector housing part 12b, the first detector housing part 36 and the second connection housing part 38 can then be pushed together in the axial direction counter to the spring force. The maximum excursion of the coil spring 110 is limited by the stop of the catches 102 at the end of the respective slot 104. The coil spring 110 is then still under preloading.

In addition to the previously described axial displaceability, the first detector housing part 36 and the second connection housing part 38 are rotatable relative to one another in far as the ring part 82 is rotatable relative to the first detector housing part 36.

The additional circuit board 92 or the connection plug 34 and the detector electronics 32 are connected to one another (not illustrated) by means of a flexible line (ribbon cable). The flexible line extends from the rear side of the connection plug 34 in a channel 111 that is provided in the outer part through an opening 112 provided in the outer part 44 up to a control circuit board 114 for the flexible line. The mounting of the connection adapter 30 is described in the following.

To form the first detector housing part 36, the main circuit board 50 of the detector electronics 32 is plugged in the specified location onto the retaining bars 48 of the support part 42 and clipped with the catches 52.

Then, the connection adapter 30 is connected to the light detector 16. For this, the light detector 16 is inserted through a corresponding accommodating opening 118 in the base plate 46 into the interior 40 of the first detector housing part 36. The connection contacts 58 of the light detector 16 then penetrate the main circuit board 50.

Then, the support part 42 is plugged in a uniquely specified relative position into the outer part 44 until the maximum insertion depth is reached and the outer part 44 and the support part 42 are locked in place. Subsequent to this, the potting compound can be poured into the interior 40.

Subsequently, the control circuit board 114 for the flexible conductor is connected to the main circuit board 50 and plugged onto the base plate 46 and clipped to the same by means of catches 116.

To mount the second connection housing part 38, the additional circuit board 92 is plugged into the ring part 82 in its unique relative position and the ring part 82 and the intermediate part 80 are plugged into one another until they are locked in place. Before the first detector housing part 36 and the second connection housing part 38 are plugged into one another, the connection plug 34 and the control circuit board 114 are connected to the flexible conductor. The coil spring 110 is arranged between the shoulder 74 of the first detector housing part 36 and the collar 84 of the connection housing part 38. Then, the first detector housing part 36 and the second connection housing part 38 are plugged into one another. Here also, the plugging-in takes place only in a specified relative position. The catches 102 of the intermediate part 80 in this case extend through the respective slot 104 in the outer part 44.

The support part 42, the outer part 44, the intermediate part 80 and the ring part 82 are in each case plugged into one another along a common plugging axis S.

After the connection adapter 30 is mounted, it is plugged into the light detector housing part 12b.

To do this, the light detector 16 is inserted together with the connection adapter 30 into the base body 28 of the detector housing part 12b. The unique relative position of connection adapter 30 relative to the base body 28 is specified £ in this case by the fixing pins 62 and corresponding openings in the base body 28. The first detector housing part 36 is therefore secured against rotation relative to the base body 28.

In the next step, the cover 26 is placed onto the second connection housing part 38. The relative position of the cover 26 in relation to the second connection housing part 38, and here in particular of the ring part 82 and cover 26, is uniquely specified by the orientation of the contact pins 34 and the connection plug 34 and by the fixing structures 100. The ring part 82 with the additional circuit board 92 and the connection plug 34 is connected to the contact pins 34 for the sensor electronics 20.

Subsequently, the cover 26 is screwed to the base body 28. The rotation taking place in this case can be compensated by the relative rotatability of second connection housing part 38 and the first detector housing part 36. The flexible line extending from the second connection housing part 38 to the first detector housing part 36 is additionally pre-bent into a plurality of windings such that it is unwound by the screw fastening.

The reducing of the length of the housing 12 in the axial direction due to the screw fastening is compensated by the axial displaceability between the first detector housing part 36 and the second connection housing part 38. The contact force on the contact pins 24 and the light detector 16 remains constant due to coil spring 110.

A further embodiment of a contact adapter 30 is described in FIGS. 7 to 12. The same reference signs are used for identical or at least functionally identical components to describe the second embodiment as to describe the first embodiment.

The connection adapter 30 is also formed in multiple parts according to the second embodiment and comprises a first detector housing part 36 and a second connection housing part 38.

The first detector housing part 36 encloses an interior 40 and surrounds and fixes the detector electronics 32 (cf. FIG. 9). The detector housing part 36 itself is formed in two parts and comprises a support part 42 and an outer part 44 (cf. FIGS. 10 and 11).

The support part 42 (which can be seen well in FIGS. 9 to 11) comprises a base plate 46 and retaining bars 48 extending therefrom in the axial direction. The retaining bars 48 are formed in a slightly resilient manner and guided laterally past a main circuit board 50 of the detector electronics 32. At their ends, the retaining bars 48 in each case have a catch 52, using which they engage behind the main circuit board 50 of the detector electronics 32 and thus fix it in a clamping manner. Furthermore, one fixing pin 54 is arranged at the end of the retaining bars 48 in each case, which fixing pin is used for anti-rotation protection of the main circuit board 50. The retaining bars 48 and fixing pins 54 are not equidistantly distributed, but rather specify a unique relative position of the main circuit board 50 relative to the support part 42. The main circuit board 50 has a plurality of connection openings 56 arranged on a circle, through which connection contacts 58 of the light detector 16 extend.

Furthermore, the support part 42 has support ribs 60 that spring inwards in the radial direction, which support ribs bear against the light detector 16 and centre and resiliently support the same.

The support part 42 is plugged with the retaining bars 48 and the detector electronics 32 into the outer part 44 and fixed in the axial direction by means of catches 64 which engage into a corresponding opening 66. For a unique relative position of the support part 42 in the outer part 44, the outer part 44 has guide rails 68 extending in the axial direction on its inner side, in which guide rails the retaining bars 48 are accommodated. As a result, anti-rotation protection is realized. The support part 42 is pushed so far into the outer part 44 until the catches 64 arranged on the base plate 46 deflect outwards into the corresponding opening 66 in the outer part 44.

The outer part 44 has a cylindrical base body with a first detector section 70 with a larger diameter and a guide section 72 with a smaller diameter adjacent thereto. Due to the two different diameters, the outer part 44 has a shoulder 74. The detector section 70 and the guide section 72 are separated by an intermediate ceiling 76.

The detector section 70 with the intermediate ceiling 76 and the base plate 46 enclose the interior 40 with the detector electronics 32. An opening 78 is formed in the base plate 46, via which potting compound can be poured into the interior 40 to protect the detector electronics 32.

The connection housing part 38 is formed only in one part according to the second embodiment.

The connection housing part 38 is formed in a cylindrical manner and has a circumferential collar 84 on one side.

The connection housing part 38 accommodates additional electronics 90 with an additional circuit board 92 with the connection plug 34 in a clamping manner. To this end, the connection housing part 38 has catches 94 which spring outwards during insertion of the additional circuit board 92 and subsequently form an end support for the additional circuit board 92. For a unique positioning of the additional circuit board 92 in the connection housing part 38, the connection housing part 38 has a projection 96 and the additional circuit board 92 has a corresponding notch 98.

Furthermore, the connection housing part 38 has three fixing structures 100 which are arranged on the end face or the collar 84 of the connection housing part 38. Together with the connection plug 34, a unique positioning of the connection housing part 38 relative to the glass feedthrough 22 and the contact pins 24 is thus specified and anti-rotation protection is realized. For positive fastening of the second connection housing part 38 to the glass feedthrough 22, the second connection housing part 38 has three means extending in the axial direction for positive fastening 101, here three snap-in hooks. These can spring outwards and engage behind the glass feedthrough.

The second connection housing part 38 is plugged into the outer part 44 of the first detector housing part 36. The connection housing part 38 is in this case plugged into the cylindrical guide section 72 with a smaller diameter. The connection housing part 38 has catches 102, which spring outwards in the radial direction and which are accommodated in a slot 104 of the outer part 44, which slot extends in the axial direction. Furthermore, the connection housing part 38 has two grooves 106 in each case laterally adjacent to the catches 102 and extending in the axial direction, into which grooves ribs 108 engage on the inner side of the outer part 44. The ribs 108 and corresponding grooves 106 and also the catches 102 and slots 104 realize guidance and anti-rotation protection.

The connection housing part 38 and the outer part 44 are displaceable relative to one another in the axial direction. As a result, the first detector housing part 36 and the second connection housing part 38 are also displaceable relative to one another in the axial direction.

A coil spring 110 is arranged between the shoulder 74 of the outer part 44 and the collar 84 of the connection housing part 38. The coil spring 110 is arranged between the shoulder 74 and the collar 84 in a captive manner. The coil spring 110 loads the first detector housing part 36 and the second connection housing part 38 with a spring force which leads to the first detector housing part 36 and the second connection housing part 38 being pushed apart in the axial direction. During mounting of the connection adapter 30 in the light detector housing part 12b, the first detector housing part 36 and the second connection housing part 38 can then be pushed together in the axial direction counter to the spring force. The maximum excursion of the coil spring 110 is limited by the stop of the catches 102 at the end of the respective slot 104. The coil spring 110 is then still under preloading.

The additional circuit board 92 or the connection plug 34 and the detector electronics 32 are connected to one another by means of a flexible line (ribbon cable) 120. The flexible line 120 extends from a pin header 122, which is connected to the detector electronics, and penetrates the intermediate ceiling, up to the rear side of the connection plug 34. The flexible line 120 extends inside the guide section 72.

The mounting of the connection adapter according to the second embodiment 30 is described in the following.

To form the first detector housing part 36, the main circuit board 50 of the detector electronics 32 is plugged in the specified location onto the retaining bars 48 of the support part 42 and clipped with the catches 52.

Then, the connection adapter 30 is connected to the light detector 16. For this, the light detector 16 is inserted through a corresponding accommodating opening 118 in the base plate 46 into the interior 40 of the first detector housing part 36. The connection contacts 58 of the light detector 16 then penetrate the main circuit board 50.

Then, the support part 42 is plugged in a uniquely specified relative position into the outer part 44 until the maximum insertion depth is reached and the outer part 44 and the support part 42 are locked in place. Subsequent to this, the potting compound can be poured into the interior 40.

To mount the second connection housing part 38, the additional circuit board 92 is plugged into the second connection housing part 38 in its unique relative position and locked in place.

Before the first detector housing part 36 and the second connection housing part 38 are plugged into one another, the flexible line 120 is connected to the pin header 122 and the additional electronics 92.

The coil spring 110 is arranged between the shoulder 74 of the first detector housing part 36 and the collar 84 of the second connection housing part 38. Then, the first detector housing part 36 and the second connection housing part 38 are plugged into one another. Here also, the plugging-in takes place only in a specified relative position. The catches 102 of the intermediate part 80 in this case extend through the respective slot 104 in the outer part 44.

The support part 42, the outer part 44 and the second connection housing part 38 are in each case plugged into one another along a common plugging axis S.

After the connection adapter 30 is mounted, it is plugged into the light detector housing part 12b.

To do this, the light detector 16 together with the connection adapter 30 is first connected to the cover 26. The unique relative position of connection adapter 30 relative to the cover 26 is specified in this case by the fixing structures 100 and corresponding openings in the glass feedthrough 22. In addition, the second connection housing part 38 locks in place on the glass feedthrough 22 by means of attached means for positive fastening 101 (snap-in hooks). Overall, the connection adapter 30 is positively fixed to the cover 26 in the axial direction and secured against rotation.

The relative position of the cover 26 in relation to the second connection housing part 38 is uniquely specified by the orientation of the contact pins 24 and the connection plug 34 and by the fixing structures 100. The second connection housing part 38 with the additional circuit board 92 and the connection plug 34 is connected to the contact pins 24 for the sensor electronics 20.

Subsequently, the cover 26 is screwed to the base body 28. The connection adapter 30 in this case rotates together with the cover 26.

The reducing of the length of the housing 12 in the axial direction due to the screw fastening is compensated by the axial displaceability between the first detector housing part 36 and the second connection housing part 38. The contact force on the contact pins 24 and the light detector 16 remains constant due to coil spring 110.

### LIST OF REFERENCE SIGNS

10 Radiometric measuring device
12 Housing
12a-12c Housing parts
14 Scintillator
16 Light detector
18 Optical window
20 Sensor electronics
22 Glass feedthrough
24 Contact pins
26 Cover
28 Base body
30 Connection adapter
32 Detector electronics
34 Connection plug
36 First detector housing part
38 Second connection housing part
40 Interior
42 Support part
44 Outer part
46 Base plate
48 Retaining bars
50 Main circuit board
52 Catch (retaining bar)
54 Fixing pins (retaining bar)
56 Connection opening
58 Connection contact of the light detector
60 Support rib
62 Fixing pin (support part)
64 Catches (base plate)
66 Opening (outer part)
68 Guide rail
70 Detector section
72 Guide section
74 Shoulder
76 Intermediate ceiling
78 Opening (base plate)
80 Intermediate part
82 Ring part
84 Collar
86 Collar (ring part)
88 Catch (ring part)
90 Additional electronics
92 Additional circuit board
94 Catch
96 Projection
98 Notch
100 Fixing structure
101 Means for positive fastening (snap-in hook)
102 Catch
104 Slot
106 Groove
108 Rib
110 Coil spring
111 Channel
112 Opening (outer part)
114 Control circuit board
116 Catch
118 Accommodating opening
120 Flexible line
122 Pin header
S Plugging axis

1. A radiometric measuring device comprising a housing, wherein a light detector is arranged in the housing and wherein a connection adapter is arranged in the housing, wherein the connection adapter is used for producing an electrical connection between the light detector and sensor electronics, wherein the connection adapter is formed at least in two parts and has a first detector housing part and a second connection housing part, wherein the first detector housing part and the second connection housing part are displaceable relative to one another in the axial direction and/or rotatable relative to one another.

2. The radiometric measuring device according to claim 1,
wherein
the first detector housing part has detector electronics for connection to the light detector and/or the second connection housing part has a connection plug for connecting to the sensor electronics.

3. The radiometric measuring device according to claim 1,
wherein
the first detector housing part and the second connection housing part are loaded with a spring force in the axial direction.

4. The radiometric measuring device according to claim 3,
wherein
a spring is arranged in a captive manner between the first detector housing part and the second connection housing part.

5. The radiometric measuring device according to claim 1,
wherein
the first detector housing part and the second connection housing part have corresponding guide means for a defined relative axial movement.

6. The radiometric measuring device according to claim 1,
wherein
the second connection housing part is formed in two parts and comprises an intermediate part and a ring part wherein the ring part is rotatable relative to the intermediate part.

7. The radiometric measuring device according to claim 6,
wherein
the second connection housing part has at least one fixing structure on an end face.

8. The radiometric measuring device according to claim 6,
wherein
additional electronics with a connection plug are arranged on the second connection housing part.

9. The radiometric measuring device according to claim 1,
wherein the second connection housing part has means for positive fastening to the housing.

10. The radiometric measuring device according to claim 1,
wherein
a connection plug in the second connection housing part and detector electronics are electrically connected to one another by means of a flexible conductor.

11. The radiometric measuring device according to claim 1,
wherein
the first detector housing part is realized in two parts and comprises a support part and an outer part.

12. The radiometric measuring device according to claim 11,
wherein
the support part has means for fixing the detector electronics.

13. The radiometric measuring device according to claim 1,
wherein
the first detector housing part has at least one fixing pin on its end face which faces away from the second connection housing part

14. The radiometric measuring device according to claim 1,
wherein
the light detector is resiliently accommodated in the first detector housing part.

15. The radiometric measuring device according to claim 1,
wherein
the connection adapter has support elements on its outer side for resilient support inside the housing.

16. A connection adapter for connecting a light detector in a radiometric measuring device to sensor electronics, wherein the connection adapter has a first detector housing part with detector electronics for connection to the light detector and a second connection housing part with a connection plug for connection to the sensor electronics, wherein the first detector housing part and the second connection housing part are displaceable relative to one another in the axial direction and/or rotatable relative to one another.

17. A method for mounting a radiometric measuring device comprising a housing, a light detector and a connection adapter, wherein the connection adapter is used for producing an electrical connection between the light detector and sensor electronics, wherein the connection adapter is formed at least in two parts and has a first detector housing part and a second connection housing part, wherein the first detector housing part and the second connection housing part are displaceable relative to one another in the axial direction and/or rotatable relative to one another, wherein the light detector is first connected to the first detector housing part and subsequently the connection adapter is arranged in the housing with the first detector housing part and the second connection housing part, wherein the connection adapter is connected in a rotationally fixed manner to a cover of the housing by means of the second connection housing part, and wherein the base body and the cover are subsequently screwed together.

18. A method for mounting a radiometric measuring device comprising a housing, a light detector and a connection adapter, wherein the connection adapter is used for producing an electrical connection between the light detector and sensor electronics, wherein the connection adapter is formed at least in two parts and has a first detector housing part and a second connection housing part, wherein the first detector housing part and the second connection housing part are displaceable relative to one another in the axial direction and/or rotatable relative to one another, wherein the light detector is first connected to the first detector housing part and subsequently the connection adapter is arranged in the housing with the first detector housing part and the second connection housing part, wherein the first detector housing part is connected in a rotationally fixed manner to a base body of the housing and the second connection housing part is connected in a rotationally fixed manner to a cover of the housing, and wherein the base body and the cover are subsequently screwed together.
